(19) United States
(12) Patent Application Publication
(10) Pub. No.: US 2013/0315418 A1
(43) Pub. Date: Nov. 28, 2013

(54) VEHICLE APPROACH NOTIFICATION UNIT

(71) Applicants: Hamanakodenso Co., Ltd., Kosai-city (JP); Denso Corporation, Kariya-city (JP)

(72) Inventors: Toshiaki NAKAYAMA, Miyoshi-city (JP); Koji SUZUKI, Hamamatsu-city (JP)

(73) Assignees: Hamanakodenso Co., Ltd., Kosai-city (JP); Denso Corporation, Kariya-city (JP)

(21) Appl. No.: 13/898,935

(22) Filed: May 21, 2013

(30) Foreign Application Priority Data
May 28, 2012 (JP) 2012-120982

(51) Int. Cl. B60Q 5/00

(52) U.S. Cl. CPC B60Q 5/008
USPC 381/86

(57) ABSTRACT

A vehicle approach notification unit produces a notification sound outside a vehicle when a predetermined driving condition is met to notify an approach of the vehicle. The vehicle approach notification unit has a cavity portion and a small speaker. The cavity portion is disposed to a component of the vehicle and has a sound space therein. The small speaker directly produces the notification sound including an audible frequency. The small speaker is disposed at the cavity portion and emits the notification sound into the sound space of the cavity portion. The cavity portion has a diaphragm or a sound outlet that emits the notification sound from the sound space of the cavity portion outside the vehicle.

### CROSS REFERENCE TO RELATED APPLICATION

This application is based on Japanese Patent Application No. 2012-120982 filed on May 28, 2012, the disclosure of which is incorporated herein by reference in its entirety.

### TECHNICAL FIELD

The present disclosure relates to a vehicle approach notification unit.

### BACKGROUND

Conventionally, a vehicle approach notification unit notifies pedestrians of an approaching vehicle with a notification sound. For instance, JP-A-10-201001 discloses a vehicle approach notification unit having a dynamic speaker, which produces a sound with audible frequencies.

The notification sound, which notifies pedestrians of an approaching vehicle, is required not to be too loud, unlike a warning sound. In addition, an artificial engine sound, chords, voice sound, and music are preferable as the notification sound.

When the notification sound includes low frequencies under 600 Hz, the notification sound becomes quieter. Accordingly, in order to produce a quieter notification sound, or to produce an artificial engine sound that is close to the real engine sound, the notification sound is required to include such low frequencies.

Employing a dynamic speaker, such as a woofer that has a large diaphragm, such as a cone paper, may be used to produce low sound. However, a large space and extra costs are needed to employ such a large dynamic speaker.

In Japanese Patent Application No. 2011-238815 (U.S. patent application Ser. No. 13/662,913), a small speaker, which is a small dynamic speaker, such as a micro speaker, is mounted to a sound tube of a vehicle horn, which produces the warning sound, to produce the notification sound. The notification sound is emitted from a vehicle via the sound tube. Accordingly, low sound produced by the small speaker is amplified by the sound tube and emitted from the vehicle.

However, there may be a case that it is difficult to dispose the small speaker at the vehicle horn because of a space limitation in the vehicle or the like. In such a case, a technology in which the sound tube of the vehicle horn amplifies the notification sound may not be able to be employed.

When the vehicle has a vehicle horn with no sound tube, the technology may not be able to be employed neither.

### SUMMARY

According to an example of the present disclosure, there is provided a vehicle approach notification unit that produces a notification sound outside a vehicle when a predetermined driving condition is met to notify an approach of the vehicle. The vehicle approach notification unit has a cavity portion and a small speaker. The cavity portion is disposed to a component of the vehicle and has a sound space therein. The small speaker produces the notification sound including an audible frequency. The small speaker is disposed at the cavity portion and emits the notification sound into the sound space of the cavity portion. The cavity portion has a diaphragm or a sound outlet that emits the notification sound from the sound space of the cavity portion outside the vehicle.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic perspective view illustrating a vehicle approach notification unit according to a first embodiment;

FIG. 2 is a block diagram illustrating the vehicle approach notification unit according to the first embodiment;

FIG. 3A is a schematic view illustrating a vehicle approach notification unit according to a second embodiment; and

FIG. 3B is a schematic view illustrating the vehicle approach notification unit of the second embodiment in which a sound passage constructing portion is modified.

### DETAILED DESCRIPTION

Embodiments of the present disclosure will be described hereafter referring to drawings. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

### First Embodiment

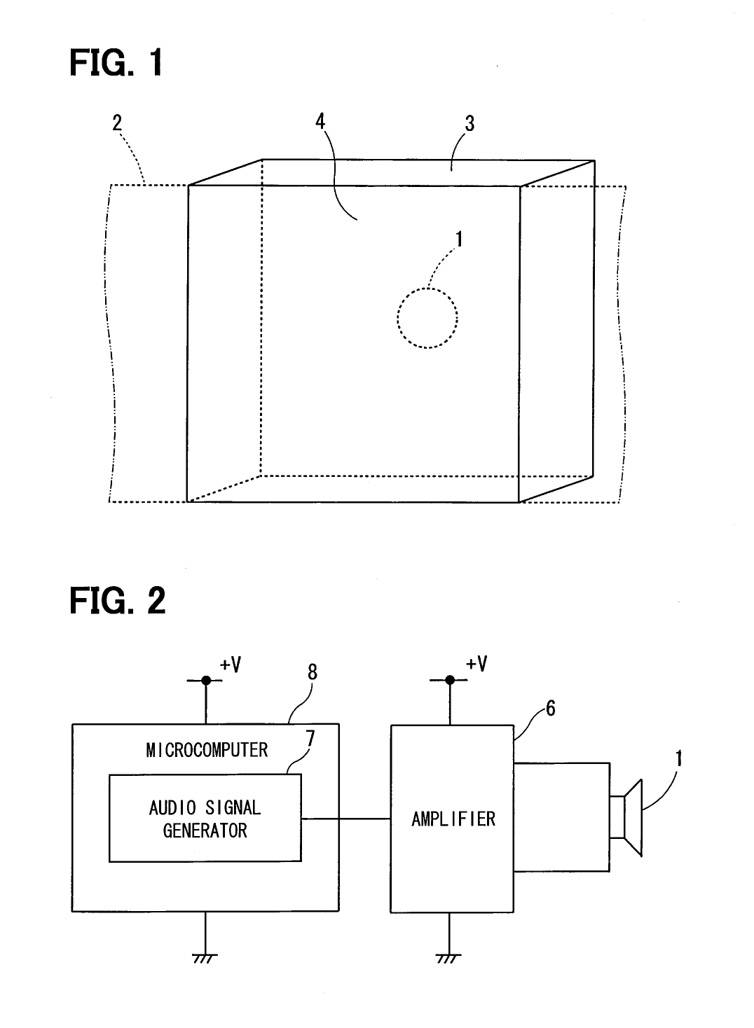

A first embodiment will be described in detail below with reference to FIGS. 1 and 2.

A vehicle approach notification unit is disposed in a vehicle that may emit a quiet sound during a drive time or a stop time. For example, the vehicle may be an electric vehicle or a fuel cell vehicle with no engine (i.e., no internal combustion engine). Also the vehicle may be a hybrid vehicle in which the internal combustion engine is stopped at the drive time and the stop time, an idling stop vehicle in which the internal combustion engine is stopped at the stop time, or an engine vehicle that drives quietly.

When a predetermined driving condition to notify pedestrians of an approaching vehicle is met, the vehicle approach notification unit produces a notification sound, such as artificial engine sound, chord, voice and music. As shown in FIG. 2, the vehicle approach notification unit includes a small speaker 1, an amplifier 6, and a microcomputer 8. The microcomputer 8 includes an audio signal generator 7 that applies an audio signal, which is a basis of the notification sound, to the amplifier 6. The amplifier 6 actuates the small speaker 1, and the small speaker 1 produces the notification sound. The audio signal may be an analog signal or a digital signal.

An engine control unit (ECU) inputs a signal, which includes driving vehicle information such as a vehicle speed, to the microcomputer 8. Based on the driving vehicle information, the microcomputer 8 determines whether the predetermined driving condition is met or not to notify pedestrians of the approaching vehicle. For example, the predetermined driving condition may be a vehicle speed that is under 20 km/h. When the predetermined driving condition is met, the microcomputer 8 actuates the audio signal generator 7 to apply the audio signal to the amplifier 6. The amplifier 6 then actuates the small speaker 1 to produce the notification sound.

The amplifier 6 amplifies the audio signal produced by the audio signal generator 7, and actuates the small speaker 1 with an amplified audio signal. A B-grade amplifier or a D-grade amplifier can be used as the amplifier 6. By controlling a signal applied to the small speaker 1, the amplifier 6 actuates the small speaker 1 to produce a frequency that generates the notification sound. In other words, the small speaker 1 produces an audible frequency that produces an audible sound.

The small speaker 1 is a micro-speaker, which has a few centimeter in diameter. According to the embodiment, a piezoelectric speaker is employed as an example of the small speaker 1. The piezoelectric speaker includes a piezoelectric element and a diaphragm. The piezoelectric element is displaced by the expansion or contraction depending on the applied voltage (charge/discharge). The diaphragm is actuated by the displacement of the piezoelectric element, and creates compressed waves in the air.

The piezoelectric speaker has a vibration system constructed by the piezoelectric element and the diaphragm, and produces an audible frequency sound. A primary resonance frequency of the vibration system is in the audible range, for example, about 2 kHz.

Because the diaphragm in the small speaker 1 is small in area, it is difficult for the small speaker 1 to produce air vibrations with a low frequency. In other words, it is difficult for the small speaker 1 to produce a low sound. In the first embodiment, as shown in FIG. 1, a cavity portion 3 is located on a part of a front bumper 2, which is an example of a component of the vehicle and located at a front part of the vehicle. The cavity portion 3 is disposed to control a tone of the notification sound, for example, the cavity portion 3 amplifies the low sound.

A disposing location of the cavity portion 3 relative to the front bumper 2 is not limited to this disclosure. The cavity portion 3 may be located at a horizontal center of the front bumper 2, or may be located on a side of the front bumper 2 that is supposed to be close to pedestrians. When the vehicle uses a left lane, the cavity portion 3 is located on the left side of the front bumper 2.

The cavity portion 3 is a container portion that has a sound space therein and may be disposed inside the front bumper 2, for example, not to be recognized from outside. A front face of the cavity portion 3 and a front face of the front bumper 2 face the same direction.

The cavity portion 3 is illustrated to have a rectangular cubic shape (i.e. a rectangular box shape) in FIG. 1, but the shape of the cavity portion 3 is not limited to the rectangular cubic shape.

The small speaker 1 is disposed at the cavity portion 3 and emits the notification sound into the sound space of the cavity portion 3.

A disposing location of the small speaker 1 at the cavity portion 3 is not limited. The cavity portion 3 may have the small speaker 1 on a partition wall constructing the cavity portion 3, for example, a rear wall of the cavity portion 3. Alternatively, the cavity portion 3 may have the small speaker 1 therein.

The cavity portion 3 emits the notification sound outside from the sound space via a diaphragm 4, which is disposed at the front face of the cavity portion 3, in other word, a side of the cavity portion 3 facing in the traveling direction of the vehicle. Here, the diaphragm 4 may correspond to a sound outlet that emits the notification sound from the sound space of the cavity portion outside the vehicle. More specifically, the diaphragm 4 is disposed to close all the sound outlet.

The diaphragm 4 divides an inside of the cavity portion 3 (the sound space of the cavity portion 3) and an outside of the cavity portion 3 (a front side of the vehicle). The diaphragm 4 is a vibrateable membrane that is vibrated by the notification sound (sound waves). The diaphragm 4 is vibrated by the notification sound in the sound space of the cavity portion 3 and emits the notification sound in front of the vehicle.

Other components of the cavity portion 3 except for the diaphragm 4 are made of a material (i.e. a stiffness material) that is restricted from vibrating by the notification sound.

The cavity portion 3 may be a resonant box that resonates with sound waves having a predetermined frequency. For example, the low frequency is determined as the predetermined frequency.

According to the first embodiment, the cavity portion 3 disposed at the front bumper 2 controls the tone of the notification sound produced by the small speaker 1.

Therefore, in a case where it is difficult to dispose the small speaker 1 at a vehicle horn because of a space limitation, the cavity portion 3 can control the tone of the notification sound produced by the small speaker 1. For example, the cavity portion 3 amplifies the low sound.

Alternatively, when the vehicle has a vehicle horn, for example, a disc horn, with no sound tube, the cavity portion 3 can control the tone of the notification sound produced by the small speaker 1.

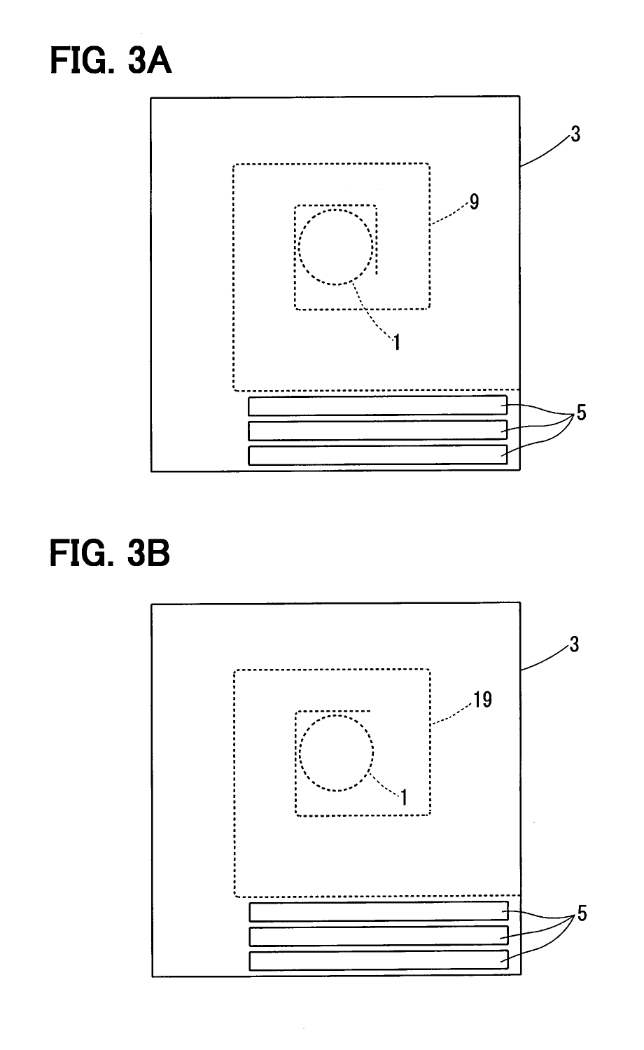

According to the first embodiment, the notification sound in the sound space of the cavity portion 3 is emitted via the diaphragm 4, so the front bumper 2 may not have a sound outlet 5 (shown in FIGS. 3A and 3B and will be described in a second embodiment) to emit the notification sound. Therefore, in the first embodiment, the sound outlet 5 may not disfigure the design of the vehicle.

Moreover, by employing the diaphragm 4 of the first embodiment, the diaphragm 4 vibrates with relatively large area, so a low frequency part of the notification sound is sufficiently amplified.

According to the first embodiment, the vehicle approach notification unit has the cavity portion 3 as the resonant box that resonates with the predetermined frequency, so the tone of the notification sound is controllable by the resonant frequency. For example, the low frequency sound of the notification sound can be amplified by setting the resonant frequency to the low frequency.

According to the first embodiment, the piezoelectric speaker producing audible sound is employed as an example of the small speaker 1. The piezoelectric speaker is a non-expensive versatile speaker, so a cost for producing the vehicle approach notification unit can decrease.

The piezoelectric speaker is smaller and lighter than a cone speaker, so the piezoelectric speaker can be disposed in the vehicle easily.

### Second Embodiment

A second embodiment will be described in detail below with reference to FIGS. 3A and 3B.

As shown in FIG. 3A, the front face of the cavity portion 3 has the sound outlet 5 made of an aperture that allows communication between inside and outside of the cavity portion 3.

The cavity portion 3 includes a sound passage constructing portion 9 therein. As shown in FIG. 3A, the sound passage constructing portion 9 divides the sound space of the cavity portion 3 and constructs a sound tube, which extends from the small speaker 1 to the sound outlet 5.

The sound passage constructing portion 9 constructs a spiral-shaped sound tube in FIG. 3A in the sound space of the cavity portion 3, however, it should be noted that a shape of the sound tube is not limited to this disclosure.

When the small speaker 1 produces the notification sound, the notification sound is emitted outside from the sound outlet 5 via the sound tube constructed by the sound passage constructing portion 9.

When the small speaker 1 produces the notification sound that includes the low frequency, the compressed waves are produced in the air. The sound tube controls the compressed waves to transmit air vibrations caused by the low frequency, and the low frequency is emitted outside from the sound outlet 5 as the low sound.

Thus, even when the vehicle approach notification unit employs the small speaker 1, the sound tube amplifies a sound pressure of the low sound, so the notification sound including the amplified low sound may be emitted outside the vehicle.

As shown in FIG. 3B, a sound passage constructing portion 19 forms a sound tube inside the cavity portion 3 and is constructed separately from the cavity portion 3. The sound passage constructing portion 19 is attached to the sound space of the cavity portion 3.

The sound passage constructing portion 19 may be fixed to the cavity portion 3 to be undetachable, for example, by adhesive, or may be attached to the cavity portion 3 by fitting, screwing or the like to be detachable.

By constructing the sound passage constructing portion 19 and the cavity portion 3 separately, and by attaching the sound passage constructing portion 19 to the cavity portion 3, the sound passage constructing portion 19 can be reconstructed easily. This is obvious from comparison of FIGS. 3A and 3B.

That is, length of the sound tube (horn length) constructed by the sound passage constructing portion 19 can be changed easily. Thus, the resonant frequency of the sound tube can be changed only by changing constructions of the sound passage constructing portion 19. That is, only by changing constructions of the sound passage constructing portion 19, an amplified frequency of the sound tube can be changed, and the tone of the notification sound can be controlled as needed.

Although one cavity portion 3 has one small speaker 1 in the first and second embodiments, one cavity portion 3 may have plural small speakers 1 to enhance a sound pressure of the notification sound.

One or more cavity portions 3 may be disposed in the vehicle. For example, one front bumper 2 may have plural cavity portions 3 to enhance a sound pressure of the notification sound.

In such a case, the tones of the notification sounds emitted from the plural cavity portions 3 may be different from each other.

Although the front bumper 2 is employed as an example of the component of the vehicle and has the cavity portion 3, the cavity portion 3 may be disposed at other parts constructing the vehicle on the front side of the vehicle. For example, the cavity portion 3 may be disposed at an air dam skirt which controls flow of air generated when the vehicle travels.

Although a piezoelectric speaker is employed as an example of the small speaker 1 in the first and second embodiments, other speakers, which are small in diameter and emit audible sound directly, such as a cone speaker having a small diameter, may be applicable.

Although the small speaker 1, which is a kind of a dynamic speaker producing audible sound directly, produces a notification sound according to the first and second embodiments, a parametric speaker may be mounted together. In such a case, the small speaker 1 produces the notification sound via the cavity portion 3, and the parametric speaker also produces a notification sound. Accordingly, both of the notification sounds may be emitted together from the vehicle.

Such changes and modifications are to be understood as being within the scope of the present disclosure as defined by the appended claims.

To sum up, the vehicle approach notification unit of the present disclosure can be described as follows.

According to the disclosure, there is provided the vehicle approach notification unit that includes the small speaker 1, which produces a notification sound. When the predetermined driving condition is met to notify pedestrians of an approach of the vehicle, the vehicle approach notification unit produces the notification sound, which is audible outside the vehicle.

The vehicle approach notification unit is disposed at the component (front bumper 2) of the vehicle and has the cavity portion 3 that has the sound space therein.

The small speaker 1 is disposed at the cavity portion 3 and emits the notification sound into the sound space of the cavity portion 3.

The cavity portion 3 may have the diaphragm 4 or the sound outlet 5, which emits the notification sound outside the vehicle. Thus, by employing the cavity portion 3, the tone of the notification sound produced by the small speaker 1 can be controlled.

What is claimed is:

1. A vehicle approach notification unit that produces a notification sound outside a vehicle when a predetermined driving condition is met to notify an approach of the vehicle, the vehicle approach notification unit comprising:
a cavity portion that is disposed to a component of the vehicle and has a sound space therein; and
a small speaker that produces the notification sound including an audible frequency, wherein
the small speaker is disposed at the cavity portion and emits the notification sound into the sound space of the cavity portion, and
the cavity portion has a sound outlet that emits the notification sound from the sound space of the cavity portion outside the vehicle.

2. The vehicle approach notification unit according to claim 1, wherein
the cavity portion is a resonant box that resonates with a predetermined frequency.

3. The vehicle approach notification unit according to claim 1, wherein
the cavity portion has a sound passage constructing portion therein to divide the sound space of the cavity portion, and the sound passage constructing portion defines a sound tube extending from the small speaker to the sound outlet.

4. The vehicle approach notification unit according to claim 3, wherein
the sound passage constructing portion is provided separately from the cavity portion, and the sound passage constructing portion is attached inside the cavity portion.

5. The vehicle approach notification unit according to claim 1, wherein
the component of the vehicle is a front bumper of the vehicle.

6. The vehicle approach notification unit according to claim 1, further comprising:
a diaphragm disposed to close all the sound outlet.

7. A vehicle approach notification unit that produces a notification sound outside a vehicle when a predetermined driving condition is met to notify an approach of the vehicle, the vehicle approach notification unit comprising:
a cavity portion that is disposed to a component of the vehicle and has a sound space therein; and
a small speaker that produces the notification sound including an audible frequency, wherein
the small speaker is disposed at the cavity portion and emits the notification sound into the sound space of the cavity portion, and
the cavity portion has a diaphragm that emits the notification sound from the sound space of the cavity portion outside the vehicle.

8. The vehicle approach notification unit according to claim 7, wherein
the cavity portion is a resonant box that resonates with a predetermined frequency.

9. The vehicle approach notification unit according to claim 7, wherein
the cavity portion has a sound passage constructing portion therein to divide the sound space of the cavity portion, and the sound passage constructing portion defines a sound tube extending from the small speaker to the diaphragm.

10. The vehicle approach notification unit according to claim 9, wherein
the sound passage constructing portion is provided separately from the cavity portion, and the sound passage constructing portion is attached inside the cavity portion.

11. The vehicle approach notification unit according to claim 7, wherein
the component of the vehicle is a front bumper of the vehicle.
